(19) United States
(12) Patent Application Publication
(10) Pub. No.: US 2005/0246308 A1
(43) Pub. Date: Nov. 3, 2005

(54) Method of exploring (arc)

(76) Inventor: Joel A. Barker, St. Paul, MN (US)

Correspondence Address: Angenehm Law Firm, Ltd., P.O. Box 48755, Coon Rapids, MN, 55448-0755, US

(21) Appl. No.: 10/800,138

(22) Filed: Mar. 12, 2004

(51) Int. Cl. G06N 7/00

(52) U.S. Cl. 706/57

(57) ABSTRACT

An investigative method, comprising a variety of strategic step controls to prevent user misuse including displaying the entire arc only when the second order implication stage is complete, allowing the option of timing from one assigned point of view only when timing was assigned, presenting third order nodes only when there is at least one positive and at least one negative second order implication, reminding the user to provide input if a predetermined amount of time has passed from the last receipt of input, permitting scoring of an arc only when scoring is assigned, disabling editability of implication text if scoring was assigned, directing a user to a scoring interface if only scoring was assigned, displaying desirability buttons and likelihood buttons when scoring, displaying a minority report interface when the minority report button is clicked, precluding acceptance of an incomplete minority report, precluding an option of time from all assigned points of view if time was not assigned and displaying options of open another arc, quit, score from all assigned points of view, time from all assigned points of view, and return completed arc.

### FIELD OF THE INVENTION

The present invention relates to tools for exploring possibilities and more particularly to tools used for exploring and evaluating the likelihood and significance of possible events.

### BACKGROUND OF THE INVENTION

People have long predicted the future. For instance, if a spouse presents flowers to their partner, they can predict that the reaction will be favorable. It is possible that the partner could not react or react negatively. Other implications are also possible. People are comfortable with predicting based upon the occurrence of an event. If “X” occurs then “Y” may be the result. From this very simplified methodology there is a very substantial room for improvement.

A tool has been developed and sold under the trademark IMPLICATIONS WHEEL® developed and sold by the current inventor, Joel A. Barker. This tool essentially follows the format of If “X” occurs then “Y” may result. The tool, identifies many of the different implications that may flow from “X.” Then additional layers may be followed out, separately treating each “Y” portion of the equation as a new “X” and looking for the next round of implications. The process may be repeated as many times as desired to reach out as far into the future as desired.

This tool has been important within corporate America due to the commercial advantage of being extremely well positioned for the future. For instance, a company may wish to understand what could result from buying out another company. Some of the immediate implications may include anti-trust problems, strategic partner benefits, combining of research and development departments and other potentially readily discernable implications. Less discernable implications are more readily uncovered with the aid of the IMPLICATIONS WHEEL® brand exploring tool. Subsequent layers of implications may also be uncovered or revealed by the tool. For instance, innovative new product may result from cross-fertilization of ideas in a combined research and development department.

The IMPLICATIONS WHEEL® brand method of predicting the future has some drawbacks until now. Previously, the tool used paper to record all the implications. The pieces of paper could become very large, covering more than an entire wall of a room. When an author desired to have arc completion groups complete the arcs, the wheel would be rolled up and mailed from location to location. There the user could engage in activities that are hurtful of the process, including editing the first order nodes, mistakes that if corrected would leave a mess on the otherwise crowded chart, chaining, e.g. completing third, fourth and higher order nodes before completing the second order nodes, failing to include both positive and negative nodes and other such problems. Charts were easily damaged and destroyed in this uncontrolled system. Arc completion groups would not always follow directions, scoring nodes when only completion was desired. This regularly resulted in complete re-writing of the work product, costing both time and money.

What is needed is an improved tool for predicting events, normally in the future, but potentially in the past. The tool should have controls to prevent errors and problems that result from failing to follow directions. For instance, the first order nodes should be protected from change. All second order nodes should be completed before third order nodes are made available for completion. Delivery should be performed electronically with confirmation. Editing and scoring of nodes should be performed with complete removal of any prior markings, avoiding the messes that otherwise clutter the work. Scoring should be allowed only when assigned and then may be required once assigned. Other features for the ease of use and comprehension should also be included to enhance the usability and understandability of the tool.

### SUMMARY OF THE INVENTION

An investigative method, which may generally be provided with the steps of determining whether the stored subscription is valid on the local computer; if the subscription is valid presenting options of downloading assigned arcs, selecting to update the subscription to the status stored on the server side, and selecting a center; if the subscription is expired presenting options of selecting to update the subscription to the status stored on the server side, and selecting a center and precluding downloading of assigned arcs; and If the subscription is not logged in, presenting the option of selecting to update the subscription to the status stored on the server side until receipt of a communication of a valid subscription from the server side and precluding downloading of assigned arcs and selection of a center.

The user may select a center and assigned arcs from the selected center are then displayed.

The method may determining if the arc was assigned for completion. Then determine whether second order implication stage is complete, assuming the arc was assigned for completion. The entire arc is displayed only when the second order implication stage is complete.

The method may determine if the arc was assigned for completion and if so directing the user to a completion interface.

The method may determine whether time was assigned. If time was assigned, options may be presented at the completion interface of open another arc, complete second order nodes, complete third order nodes, scoring from one assigned point of view, timing from one assigned point of view, spell check, return completed arc, and quit. If time was not assigned, options may be presented of open another arc, complete second order nodes, complete third order nodes, scoring from one assigned point of view, spell check, return completed arc, and quit, while precluding an option of timing from one assigned point of view.

The user may select an option of completing third order nodes. The method determines whether there is at least one positive and at least one negative second order implication. Presentation of third order nodes is precluded unless at least one positive and at least one negative second order implications are present. That is, third order nodes are presented only when there is at least one positive and at least one negative second order implication.

When the user selects to complete second order nodes or complete third order nodes, a delay may occur for a period of time to allow a user to think about implications. A clock may govern the delay. A second clock may be maintained to measure a period of time delay between user input. The user is reminded to provide input if a predetermined amount of time has passed from the second clock.

The method may determine if scoring was assigned. Scoring may be permitted only when scoring is assigned. Editability of implication text may be disabled if scoring was assigned. The user is directed to a scoring interface.

When scoring, the method may display desirability buttons and likelihood buttons with or without a minority report button. A minority report interface is displayed when the user clicks the minority report button. The method verifies that the minority report interface is fully prepared prior to accepting any data contained in the report and precludes acceptance of an incomplete minority report.

At the scoring interface, the method :may determine whether time was assigned. Options are displayed of open another arc, quit, score from all assigned points of view and return completed arc. An option of time is precluded from all assigned points of view if time was not assigned. If time was assigned, options of open another arc, quit, score from all assigned points of view, time from any assigned points of view, and return completed arc are displayed.

Several advantages are provided from these methods, including allowing users to complete the work which was initiated during the subscription period and yet preclude perpetuation of the options available to valid accounts when the subscription expires.

As yet another advantage, the user can select a center for completion or scoring without allowing their own personal bias toward the particular arcs they have been assigned to steer them toward or away from working on a particular center.

As still yet another advantage, the user is required to determine implications based upon a parent node before the user can begin identifying higher order implications, since the entire arc is displayed only when the second order implication stage is complete.

Yet another advantage is that users who have been assigned to complete an arc are directed to a completion interface, revealing only those completion options available within the scope of their assignment.

As an example of the preceding advantage, a user that was assigned time may be presented options at the completion interface of open another arc, complete second order nodes, complete third order nodes, scoring from one assigned point of view, timing from one assigned point of view, spell check, return completed arc, and quit.

As still another advantage, if time was not assigned the user is presented with options of open another arc, complete second order nodes, complete third order nodes, scoring from one assigned point of view, spell check, return completed arc, and quit and precluded from an option of timing from one assigned point of view.

As an additional advantage, linear chaining of implications and rushing through thought is avoided, since presentation of third order nodes is precluded unless at least one positive and at least one negative second order implications are present. That is, third order nodes are presented only when there is at least one positive and at least one negative second order implication.

As still another advantage, progress is encouraged by maintaining a clock for a period of time measuring delay between user input and reminding the user to provide input if a predetermined amount of time has passed from the last receipt of input.

As yet another advantageous control scoring of an arc may be permitted only when scoring is assigned.

Another control advantage is that editability of implication text is disabled if scoring was assigned.

As still another advantage a user is directed to a scoring interface if scoring was assigned, permitting only options available to those who have been assigned scoring.

Yet another advantage is that desirability buttons and likelihood buttons are displayed when scoring.

A further advantageous feature is that a minority report button is displayed when scoring.

Still yet another advantage is that a minority report interface is displayed when the minority report button is clicked.

Another control advantage is that the minority report interface is required to be fully prepared prior to accepting any data contained in the report and precludes acceptance of an incomplete minority report.

As another control feature that is advantageous is that options are displayed for open another arc, quit, score from all assigned points of view and return completed arc and the user is precluded from the option of time from assigned all point of view if time was not assigned. Yet, when time is assigned that user is displayed the options of open another arc, quit, score from all assigned points of view, time from all assigned points of view, and return completed arc.

These and other advantages are further explained in the description, shown in the drawings and illustrate in the appendix.

### DESCRIPTION OF THE DRAWINGS

FIG. 1 is a flowchart showing a preferred logic for launch and registration;

FIG. 2 is a flowchart for opening a file and showing the initial screens;

FIG. 3 is a flowchart showing the completion interface;

FIG. 4 is a flowchart showing editing of nodes;

FIG. 5 is a flowchart showing the process for adding currently unidentified implications;

FIG. 6 is a flowchart showing scoring in completion mode;

FIG. 7 is a flowchart showing timing;

FIG. 8 is a flowchart showing spell check;

FIG. 9 is a flowchart showing scoring interface;

FIG. 10 is a flowchart showing scoring in timing mode;

FIG. 11 is a flowchart showing timing;

FIG. 12 is a screen shot showing an introductory screen, listing the assigned arcs when the subscription is not current;

FIG. 13 is a screen shot showing an introductory screen, listing the assigned arcs when the subscription is current;

FIG. 14 is a screen shot that may appear to acquire subscription log-in data;

FIG. 15 is a screen shot that may appear to acquire subscription log-in data;

FIG. 16 is a screen shot that may appear to acquire subscription log-in data;

FIG. 17 is a screen shot that may appear to acquire subscription log-in data;

FIG. 18 is a screen shot showing an introductory screen, listing the assigned arcs when the subscription is current;

FIG. 19 is a screen shot showing the center and background with first order implication;

FIG. 20 is a screen shot providing for entry of the second order implications;

FIG. 21 is a screen shot showing the full arc and entry of a third order implication;

FIG. 22 is a screen shot showing the center, background and points of view assigned;

FIG. 23 is a screen shot showing the full arc in detailed scoring mode;

FIG. 24 is a screen shot showing the full arc in fast scoring mode;

FIG. 25 is a screen shot showing an interface window;

FIG. 26 is a screen shot showing an interface window;

FIG. 27 is a screen shot an interface window;

FIG. 28 is a screen shot showing a reminder window;

FIG. 29 is a screen shot showing the full arc in timing mode;

FIG. 30 is a screen shot showing the first and second order implications with a second order implication being entered;

FIG. 31 is a screen shot showing two timers and a rule reminder;

FIG. 32 is a screen shot showing a progress reminder;

FIG. 33 is a screen shot showing a reminder to include both positive and negative implications;

FIG. 34 is the screen shot showing first and second order implications;

FIG. 35 is a screen shot showing the minority report interface;

FIG. 36 is a screen shot showing a reminder to complete the minority report interface;

FIG. 37 is a screen shot showing the full arc in timing mode;

FIG. 38 is a screen shot showing the full arc in spell check mode;

FIG. 39 is a screen shot showing a portion of the scoring interface; and

FIG. 40 is a screen shot showing a portion of the scoring interface.

### DETAILED DESCRIPTION OF THE PREFERRED EMBODIMENT

Definitions

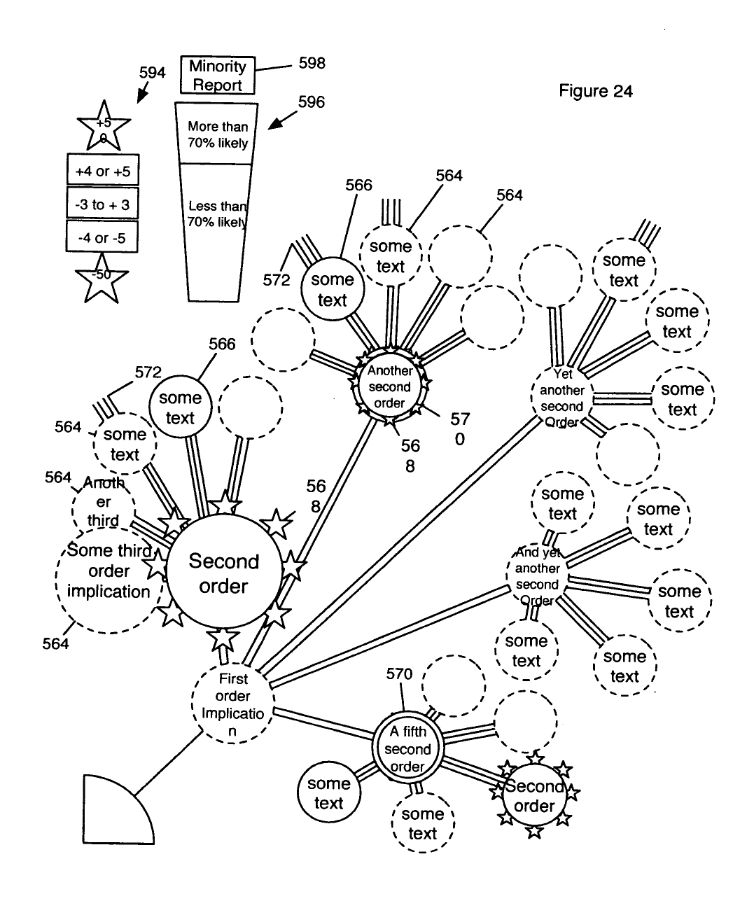

An applicant is entitled to be his own lexicographer. Accordingly, applicant chooses the following definitions to apply to the description, claims and abstract, except as may otherwise be augmented in the detailed description:
Ancestor—An ancestor of a first or subsequent order implication or node is the center and any implication/node between the center and the reference implication/node.
Arc—An arc is a portion of a wheel, the data from which can be combined with existing data into a wheel. An arc is made up of one first order implication followed by up to preferably 10 second order implications followed by up to preferably ten third order implications off of each second order implications. In a sense it is a fractal of the complete wheel, but its presented shape may be a wedge instead of a wheel. An example of an arc is shown in FIG. 34.
Center—The main or principle issue being explored with a wheel. Possible category centers include: an innovation, an emerging trend, a new policy, a new product brought out by a competitor; or a significant event, i.e. 9/11.
Center node—The node in a wheel that represents the center of the wheel and the starting point of the discussion.
Child (Children)—Any implication that has the reference implication as its parent is a child of the reference implication. Any implication that has the center as its parent is a child of the center.
Completion mode—A mode of operating the program where new implications may be added, existing implications, except for the first order implications may edited and scoring and timing may be permitted.
Diminished node—A condensed node, opposite of enlarged node.
Descendent—Any implication that has the reference implication as its ancestor is a descendent of the reference implication. Any first or subsequent order implication is a descendent of the center.
First (and subsequent) order implication—A direct possible implication of the center. A second order implication is an immediate possible implication resulting from the occurrence of a first order implication. Subsequent levels of implications, third order, fourth order, etc., are direct possible implications resulting from the occurrence of the immediate preceding order of implication. I.e. parent implication.
First (and subsequent) order node—The graphic form that holds the text of a first order implication. Second order, third order, fourth order, etc. nodes correspond to similarly numbered implications.
Implication—A possible result or consequence that is triggered by a previous event. Implications Wheel® —A brand of a team tool that help users discover possible future events in an orderly yet divergent pattern. An Implications Wheel® brand wheel is built using a disciplined methodology and a non-linear thinking process. Preferably, a wheel is displayed as a grouping of all desired orders of all identified possible implications flowing out of a single event.
Lead—A portion of a line extending partially between two nodes. A lead is displayed when one of the two nodes is not displayed. A lead is shown as part 572 in FIG. 24, e.g. four lines to a fourth order node with part of the line and the fourth order node not showing.
Lines—A connector between two nodes. A line may be paired with one or more lines as described below.
Magnified Node—An enlarged node, opposite of diminished node.
Minority opinion—A scoring opinion or a potion of a group that constitutes less than a majority.
Minority report—The scoring result as prepared by those holding a minority opinion.
N (Nth)—A mathematical variable.
Node—An area in which data concerning an implication may be recorded or displayed. Preferably, a node is displayed in the shape of a circle or oval, with certain very special nodes displayed in the shape of a star or other non-circular shape. A node may be displayed as diminished, normal or enlarged.
Order—The number of ancestors of the reference implication.
Parent—The parent of some implication is the immediate ancestor of the reference implication. That is, the ancestor that is connected to the reference implication without intervening implications.
Point of View—The perspective used for scoring of a node, arc, or wheel done by one entity, person or group. Any wheel can be scored from multiple points of view, e.g., legal, engineering, marketing, staff, natural and/or other.
Reference implication—The implication being discussed or chosen. Syn. Selected implication.
Scoring mode—The mode of operating the program where implications may not be added or edited, but may be scored and timed.
Sibling implications—Children of the same parent implication.
Significant node—A node that is scored a +4 or greater score or −4 or lesser score.
Strand—The chain of implications II being ancestors of the same implication, including that reference implication and reaching all the way back to include the center.
Time Diamond—An area in which judgements concerning the amount of time between implications is indicated.
Timing mode—A mode of operating the program where time diamonds may be entered or edited. Timing is a subset of completion mode or scoring mode.
Wheel—A graphical representation of all identified implications that may directly or indirectly flow from a given center. Implications Wheel® is the preferred brand of a wheel. An example of a wheel is shown in FIG. 41.
   Launch and Registration

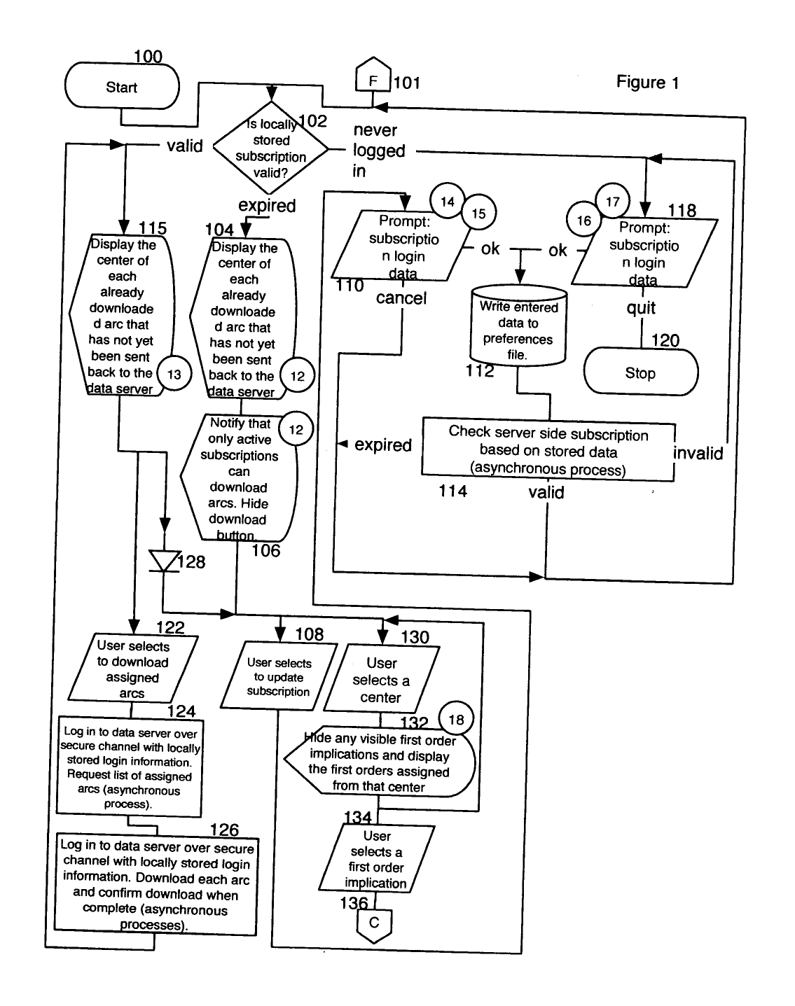

FIGS. 1-11 are flowcharts demonstrating a preferred methodology for making and using the present invention, arc completion and scoring. Referring to FIG. 1, ovals, such as oval 100, demonstrate a terminal point in the method. Oval 100 indicates the starting point for the future exploration method, which may be initiated in any manner known in the art, including those manners known in the art of computer software. This flow chart discussed in reference to FIG. 1 may connect into other parts of the overall process with the user entering through pentagon 101. (A pentagon, such as pentagon 101, indicates a point of connection to other parts of the flowchart having the same letter disposed within the pentagon. An upright pentagon, such as pentagon 101 indicates a point of entry and an inverted pentagon, such as pentagon 136 indicates a point of departure.)

Diamonds, such as diamond 102, indicate a methodology decision making point. Diamond 102 determines whether the subscription for the use of the methodology is current. Remuneration models other than subscription may be used, however, the present inventor opines that subscriptions are the best manner of offering the present invention for use. The determination at diamond 102 checks the local computer to see if the subscription is current and valid. Three possible outcomes to this decision are “valid,” “expired,” and “never logged in.” “Never logged in” occurs the first time an instance of the program is executed on a given local computer and thereafter until a valid subscription is confirmed with the server.

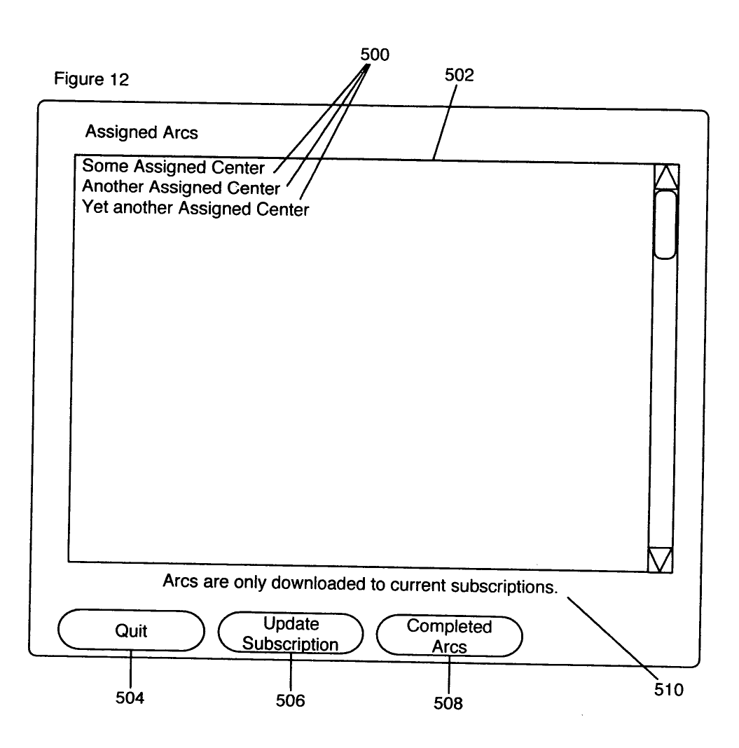

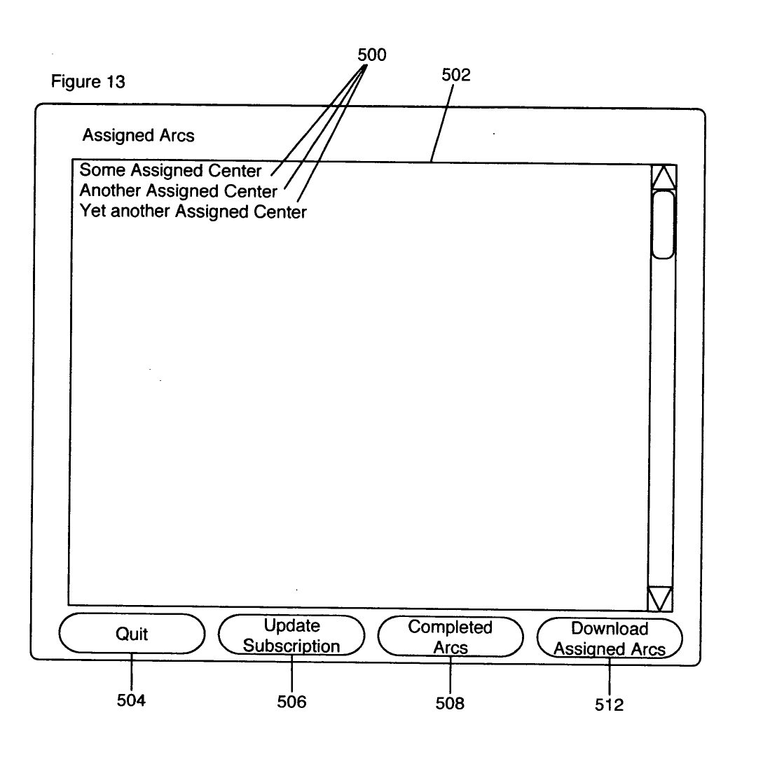

Expired—If the subscription has expired the next step is indicated by oval-arrow 104. Oval-arrows, such as oval-arrow 104, indicate a display of particular information to the user. In the case of oval-arrow 104 each center 500 of each previously downloaded arc that has not been sent back to the data server is displayed in field 502, perhaps as shown in FIG. 12. Buttons 504, 506 and 508 may present options available to the user as will be described shortly. At oval-arrow 106, the user is notified that only active subscriptions can download arcs, perhaps as shown on line 510 of FIG. 12, and the method hides the download button 512 as may be seen by comparing FIG. 12 and 13. The encircled number touching on oval-arrow 106 encases indicia with such indicia being a referenced figure number of the drawings. (Similar circles throughout this application having different indicia refer to different figures with a corresponding number to that shown in the circle.) The user may selecting to update the subscription, button 506 of FIG. 12 and 13 and parallelogram 108 of FIG. 1, which directs the user to the step indicated in parallelogram 110, which will be described in a moment. A parallelogram, such as parallelogram 110, is a point in the method seeking user input.

Parallelogram 110 is reachable from a different set of steps. For instance, if the locally stored subscription is “valid”, see diamond 102, the center is displayed of each previously downloaded arc that has not yet been sent back to the data server, oval-arrow 114, as shown in field 502 of FIG. 13. At this point the user may also select to update the subscription, parallelogram 108 of FIG. 1, which leads the user to the step indicated in parallelogram 110.

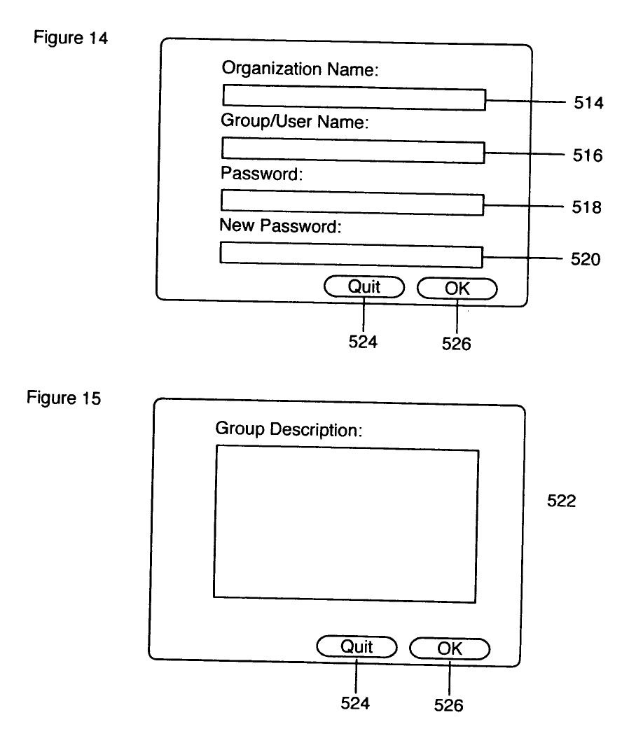

One or more prompts for subscription login data may be presented such as that shown in FIGS. 14 and 15, parallelogram 110 of FIG. 1. In the prompt shown in FIG. 14, a user may record various identifying information, perhaps as suggested in field 514 (organization name), field 516 (Group/user name), field 518 (password), field 520 (new password if a change is desired) and/ or other identifiers. A description of the group may be written in field 522 of FIG. 15. Selecting “cancel”, button 524, from either prompt shown in FIGS. 14 or 15 directs the method back to the step indicated and previously discussed with regard to diamond 102. Upon completion of the fields the user may select “o.k.”, button 526 directing the method to write the data to the preferences file, cylinder 112. A cylinder in a flowchart, such as cylinder 112, is a point in the method where data is either written to or read from storage.

The server side computer is checked based upon stored data, an asynchronous process, wherein three potential results may occur, expired, valid, or invalid, rectangle 114. If the account is expired, the user may be notified and directed to previously described diamond 102, allowing the user to engage in those activities permitted to expired accounts. If the submitted subscription data is valid, the user is directed to previously described diamond 102, allowing the user to engaged in those activities permitted to valid accounts. If the submitted data is invalid, the method moves to the step indicated by parallelogram 118, also reachable from diamond 102 with a “never logged in” result. A prompt similar to that described in regard to parallelogram 110 is presented, see FIGS. 16 and 17. The user has the option to enter subscription data and moving to the sequence of steps starting with the step previously described in regard to cylinder 112 or quitting. Selection of quitting, causes the methodology to terminate, oval 120.

If the subscription is valid, diamond 102, two other option are available to the user following the previously described display, oval-arrow 115. The user may download additional assigned arcs, parallelogram 122. The system logs into the data server over a secure channel with the locally stored login information and a request is made for a list of assigned arcs, rectangle 124. This may be an asynchronous process. The system then logs into the data server over a secure channel with locally stored login information and downloads each arc, confirming each download when complete, rectangle 126. The also may be an asynchronous process. Upon completion of the download, the method is directed to the display step previously described in regard to oval-arrow 115. The flowchart indicator 128 is a symbol showing that the option of downloading assigned arcs is not an option available to expired subscriptions.

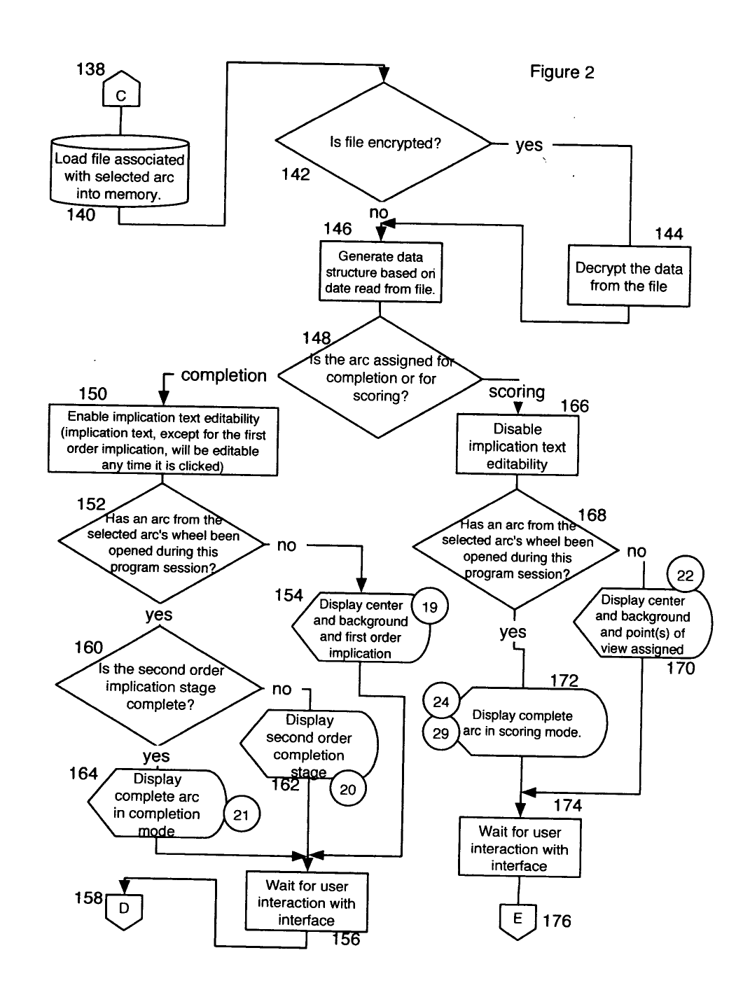

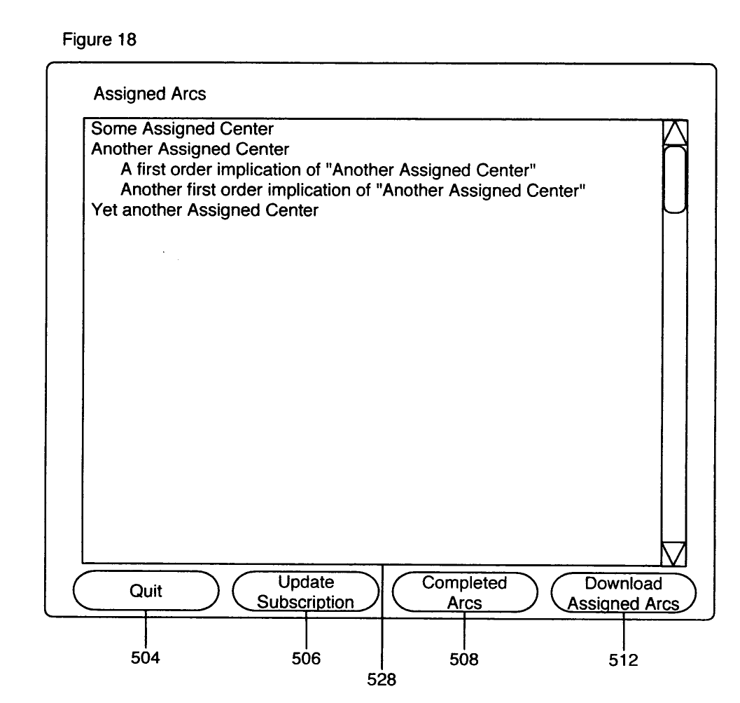

Valid and expired subscriptions also have the option of selecting a center, parallelogram 130. Any visible first order implications are hidden and then any assigned first order implications from the selected center are displayed in field 528, oval-arrow 132, as shown in FIG. 18. The user may then select a first order implication, parallelogram 134 and, as indicated by pentagon 136, the method is directed to the method steps for opening the file and showing the initial screens as set forth in FIG. 2, pentagon 138.

Opening Files and Showing Initial Screens

Referring now to FIG. 2 and entering through pentagon 138 the file associated with the selected arc is loaded into memory, cylinder 140. A decision is made as to whether the file is encrypted, diamond 142. Note, that files preferably are always encrypted prior to sending through the server, but after it is loaded into the memory, each subsequent save may not be encrypted. If encrypted, the data from the file is decrypted, rectangle 144. The decrypted data, recently or previously, is used to generate a data structure based upon data read from the file, rectangle 146. A decision is made as to whether the arc was assigned for completion or scoring, diamond 148.

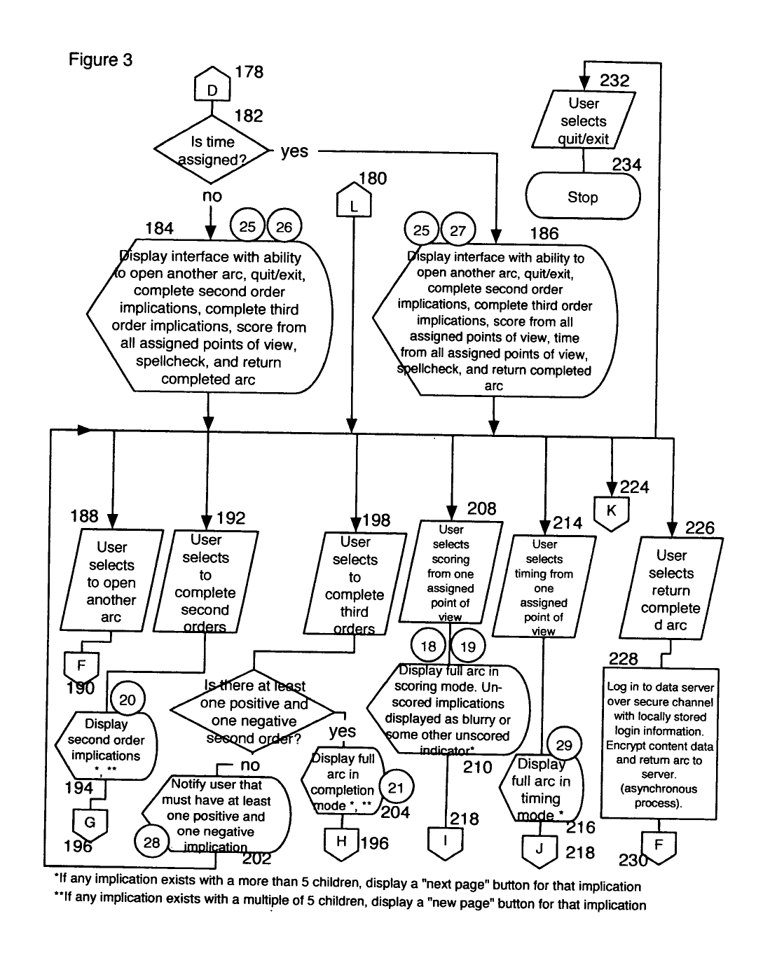

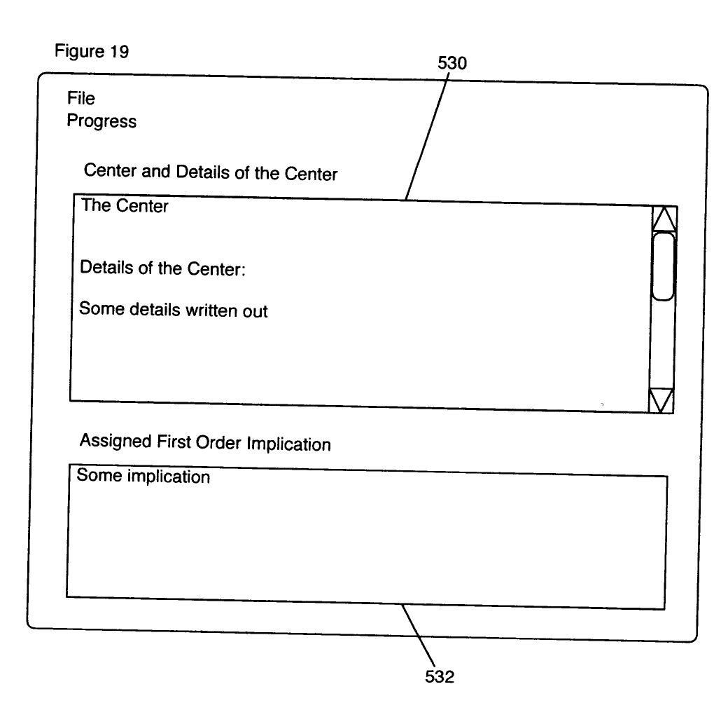

For those assigned for completion, a process step is performed. Particularly, the implication text edit-ability is enabled, rectangle 150. The text in the first order node is not made editable at anytime during the process shown in FIGS. 1-11. This is a control process as this method is generally used in conjunction with a wheel method, which allows the sending out of arc assignments. Those sending out the arc assignments are allowed to control the assignment as specified in the first order nodes, which are non-editable to those receiving the assignments. A decision is made as to whether any arc from the wheel associated with the selected arc been opened during the current program session, diamond 152. If no, the center is displayed together with the background in field 530 and assigned first order implications may be shown in field 532, oval-arrow 154, as shown in FIG. 19. This allows the user to fully understand the purpose and goals of the wheel, and hence the arc the user has selected. The method then waits for user interaction with the completion interface as set forth in FIG. 3, rectangle 156 and pentagon 158.

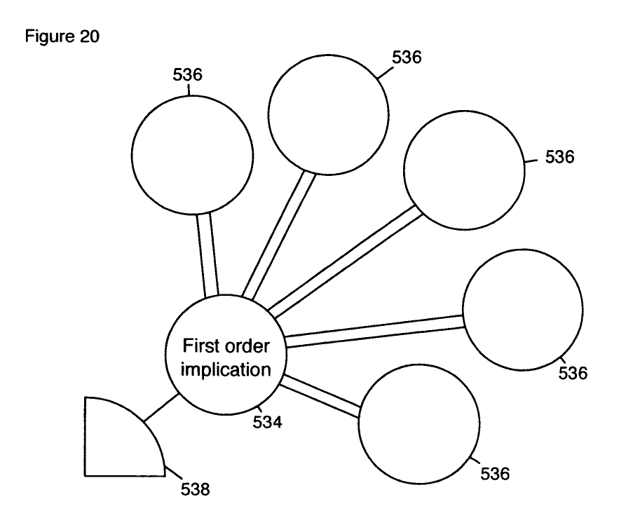

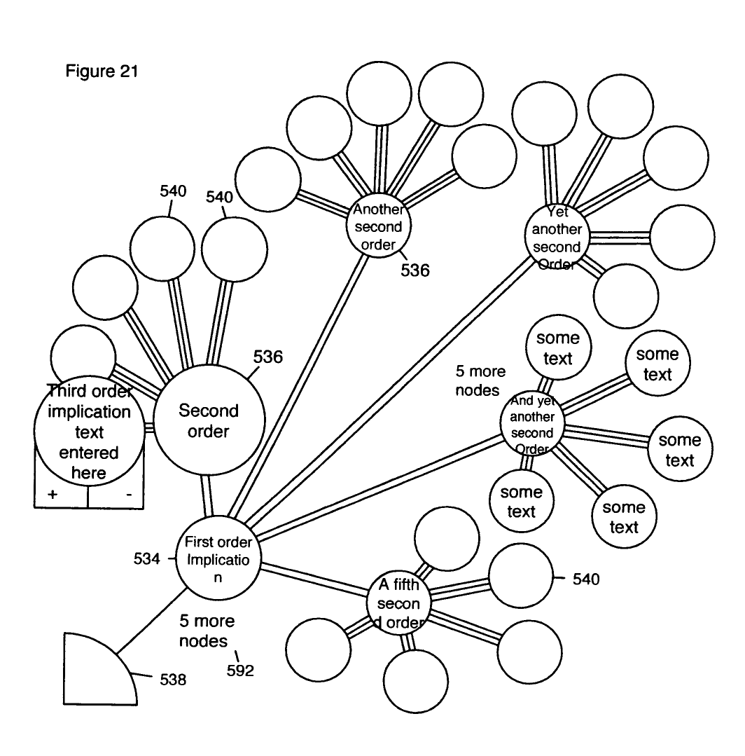

Another decision is made, diamond 160, if an arc from the wheel associated with the selected arc has been opened during the current program session. See diamond 152. In particular a decision is made as to whether the second order implication stage is complete, diamond 160. If no, the second order completion stage is displayed, oval-arrow 162 and FIG. 20. Note that the first order implication 534 and second order nodes 536 together with any second order implications are displayed. A portion of the center node 538 may also be shown. If yes, the complete arc is displayed in completion mode oval-arrow 164 and FIG. 21. The center node 538, first order node 534, second order nodes 536 and third order nodes 540 may all be displayed. The method then waits for user interaction with the completion interface as set forth in FIG. 3, rectangle 156 and pentagon 158.

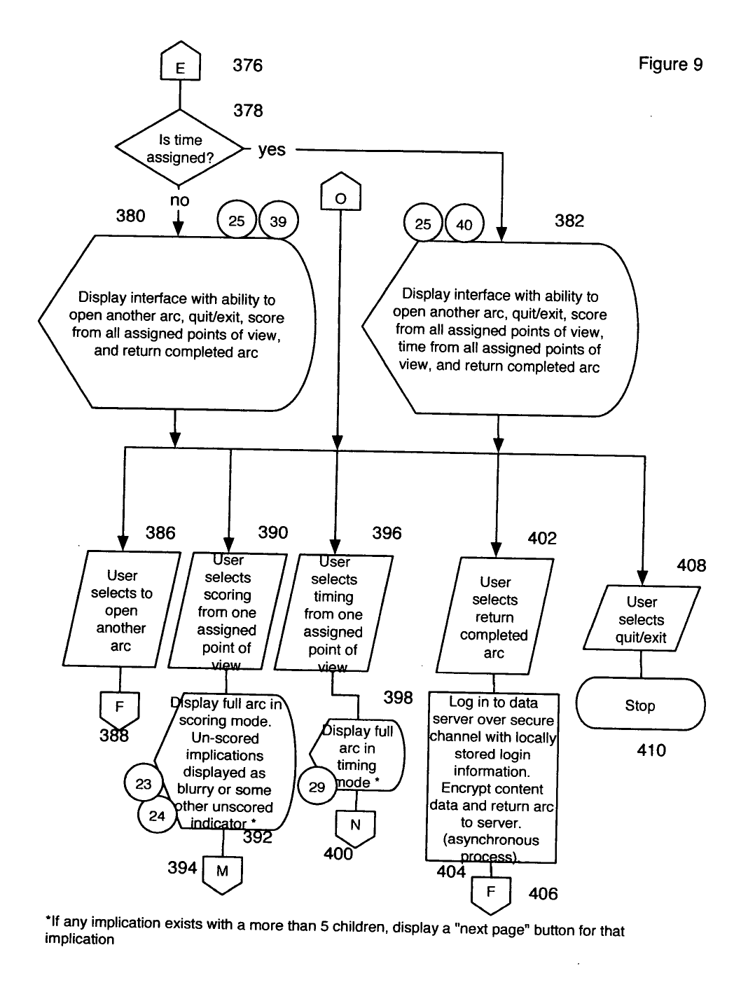

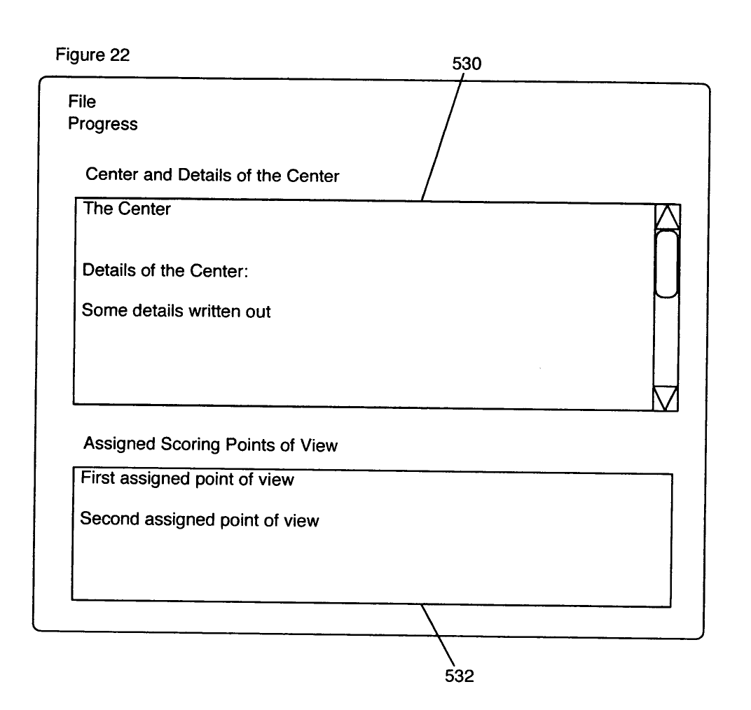

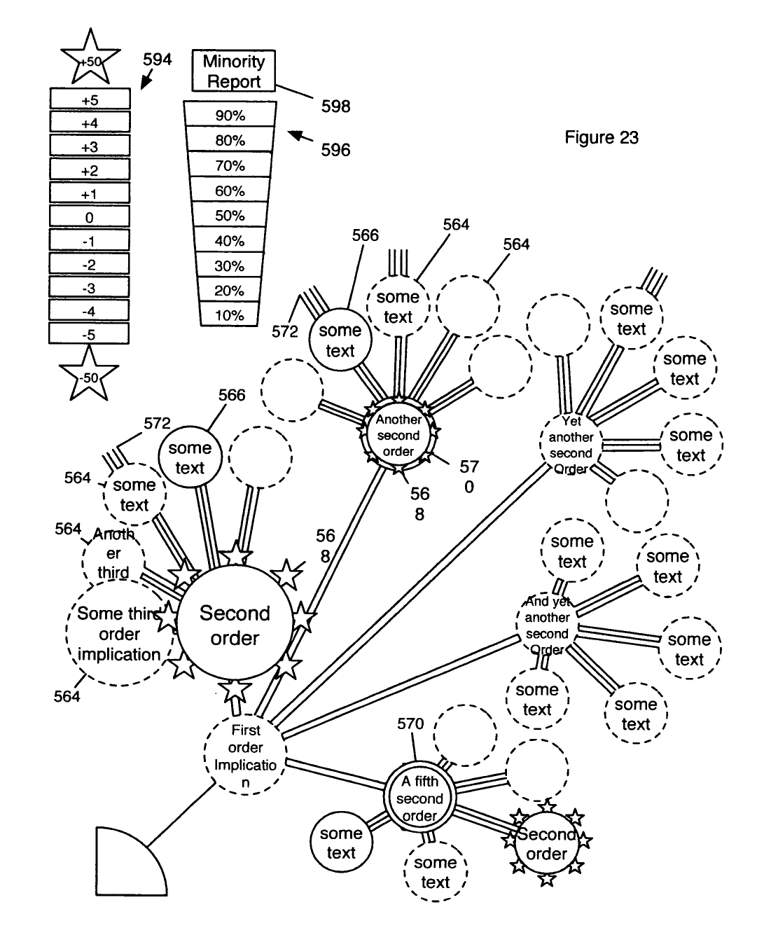

If the arc was assigned for scoring, diamond 148, implication text edit-ability is disabled, rectangle 166. A decision is made as to whether any arc from the wheel associated with the selected arc has been opened during the current program session, diamond 168. If no, the center and background, shown in field 542 and assigned point(s) of view, shown in field 544 are displayed, oval-arrow 170, perhaps as shown in FIG. 22. (Note, the text in the figures is merely offered to aid in identification of the location and is not presented as an implication or description relative to a particular issue being examined with the methodology.) If yes, the complete arc is displayed in scoring mode with un-scored implications displayed with indicia marking the nodes as un-scored, perhaps blurry lines or other indicator, oval-arrow 172. See FIGS. 23 and 24. Following either the step described in regard to oval-arrow 170 or oval-arrow 172, the method waits for user interaction with the scoring interface, rectangle 174 and pentagon 176, as described with regard to FIG. 9 starting at pentagon 376.

Completion Interface

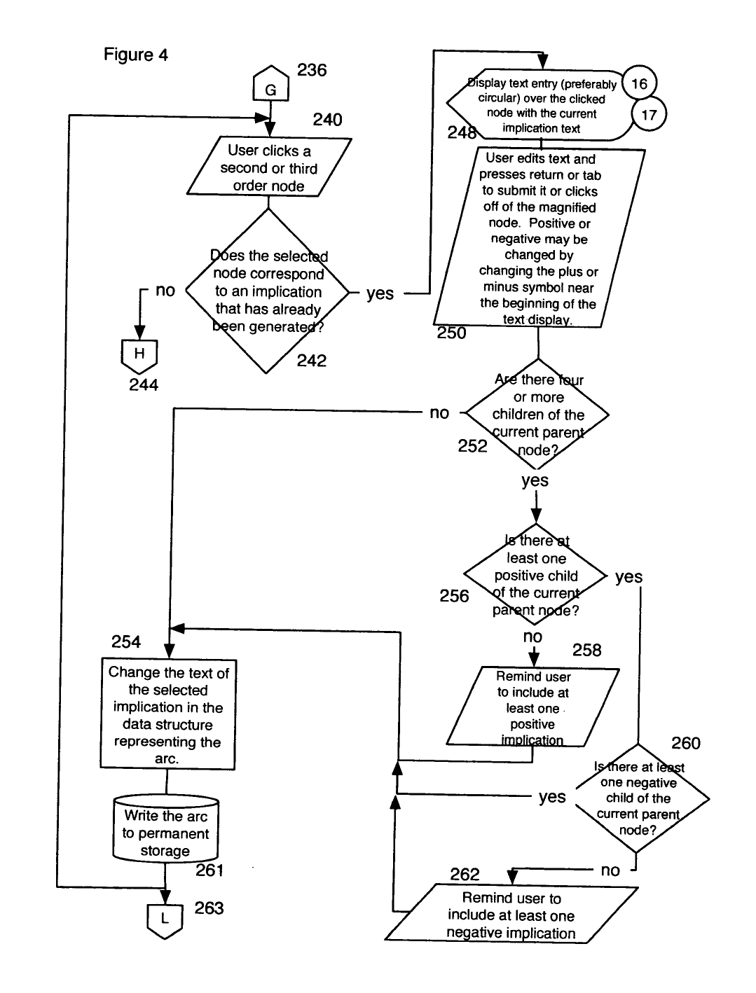

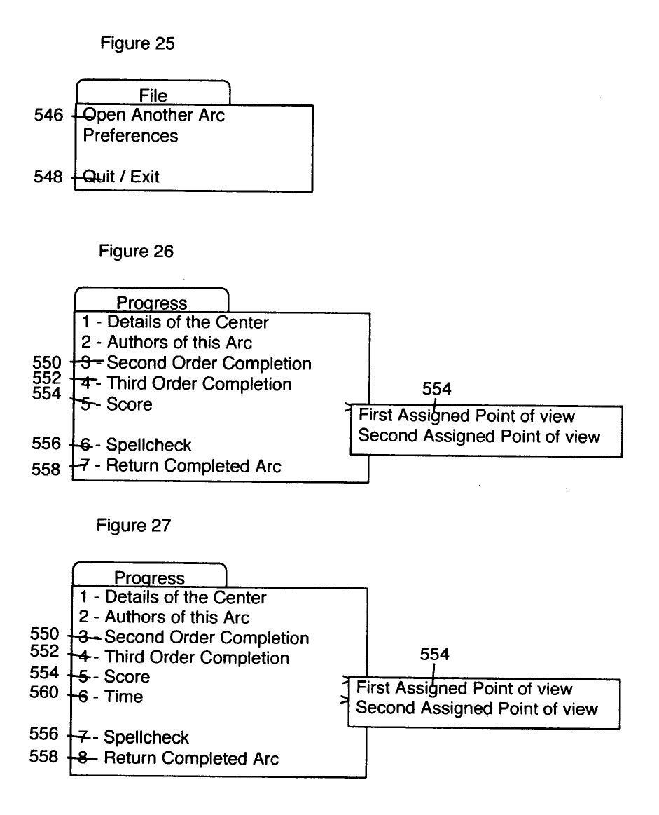

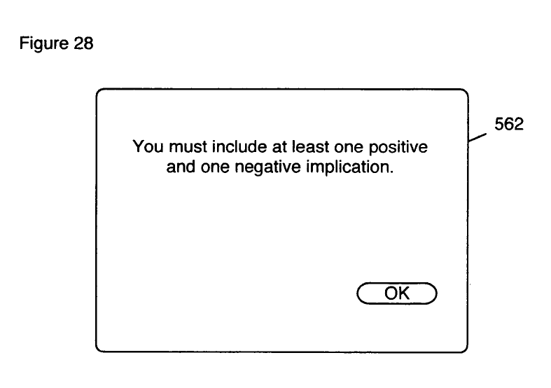

The completion interface may be entered either at pentagon 178 from pentagon 158 of FIG. 2 or pentagon 180 from FIG. 4 (pentagon 263), 5 (pentagon 298), 6 (pentagon 320), or 7 (pentagon 350). Assuming the completion interface is entered from pentagon 178, a decision, diamond 182, is made as to whether time was assigned. If no, the interface is displayed with the options to open another arc 546, quit or exit 548, complete second order implications 550, complete third order implications 552, score from all assigned points of view 554, spell check 556, and return the completed arcs 558, oval-arrow 184. FIGS. 25 and 26 are examples of what the display may show. Note, that the user is precluded from having the option of entering time as such option is not presented whether user enters from pentagons 178 or later 180 as the methodology recalls the decision at diamond 182. If time was assigned, the interface is displayed with the options to open another arc 546, quit or exit 548, complete second order implications 550, complete third order implications 552, score from all assigned points of view 554, time from all assigned points of view 560, spell check 556, and return the completed arcs 558, oval-arrow 186. FIGS. 25 and 27 are examples of what the display may show.

Whether reaching the present point in the method from oval-arrow 184, oval-arrow 186 or pentagon 180, the user is presented with several options, except as otherwise noted. At parallelogram 188, the user may select to open another arc wherein the method follows the step previously described starting with diamond 102 on FIG. 1. See pentagons 190 FIG. 3 and pentagon 101 of FIG. 1.

The user may select to complete second order implications, parallelogram 192, whereupon the second order implications are displayed, oval-arrow 194, as shown in FIG. 20. A portion of the center 538, the first order node 534 and second order nodes 536 are displayed. The user is then directed, pentagon 196, to the node editing procedure shown starting at pentagon 236 of FIG. 4.

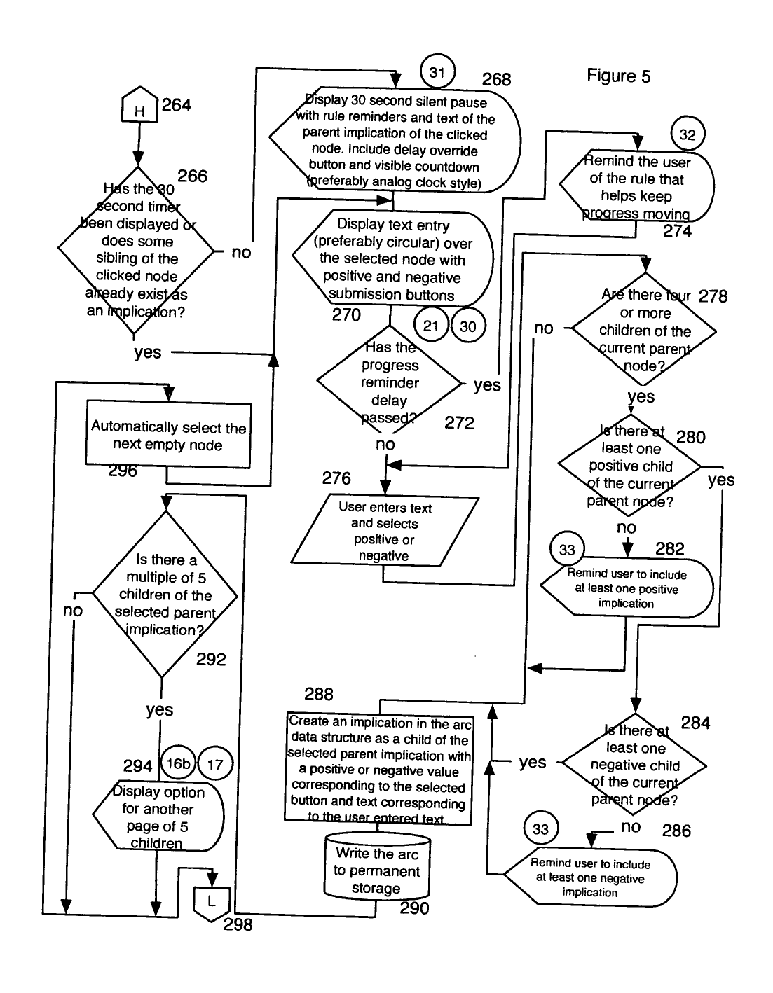

The user may select to complete third order implications, parallelogram 198, which invokes a decision as to whether there is at least one positive and one negative second order implication, diamond 200. If no, the user is notified, perhaps in window 562, that they must have at least one positive and one negative second order implication, oval-arrow 202, and is directed to select another option. That is, the user cannot enter implications of a new order until there is at least one positive and one negative implication of the current order. If yes, the full arc is displayed in completion mode, oval-arrow 204 as shown in FIG. 21 and has been previously described. The user is directed via pentagon 196 to the method described in reference to pentagon 236 of FIG. 5.

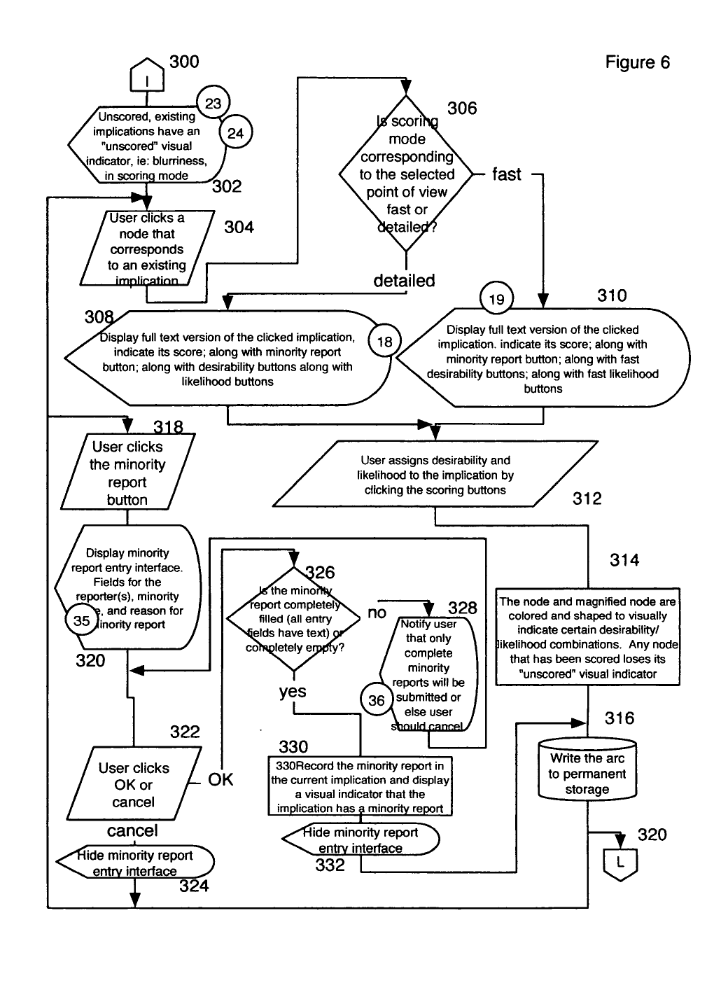

The user may select to score from one assigned point of view, parallelogram 208. The full arc is then displayed in scoring mode with un-scored implications bearing indicia, perhaps blurry or jagged lines 564 defining the node, such indicia indicating the unscored nature of such node, oval-arrow 210 such as found in FIGS. 23 and 24. Scored nodes that are not scored as being significant may have indicia such as solid lines 266, indicating that the nodes have been scored. Nodes scored as significant may have indicia such as stars 268 disposed about the node. Nodes scored with a high likelihood may bear indicia such as a second circle 270. Leads 272 may indicate the presence of non-displayed higher order implications. The user is then directed, pentagon 212, to the steps concerning scoring in completion mode at pentagon 300 of FIG. 6.

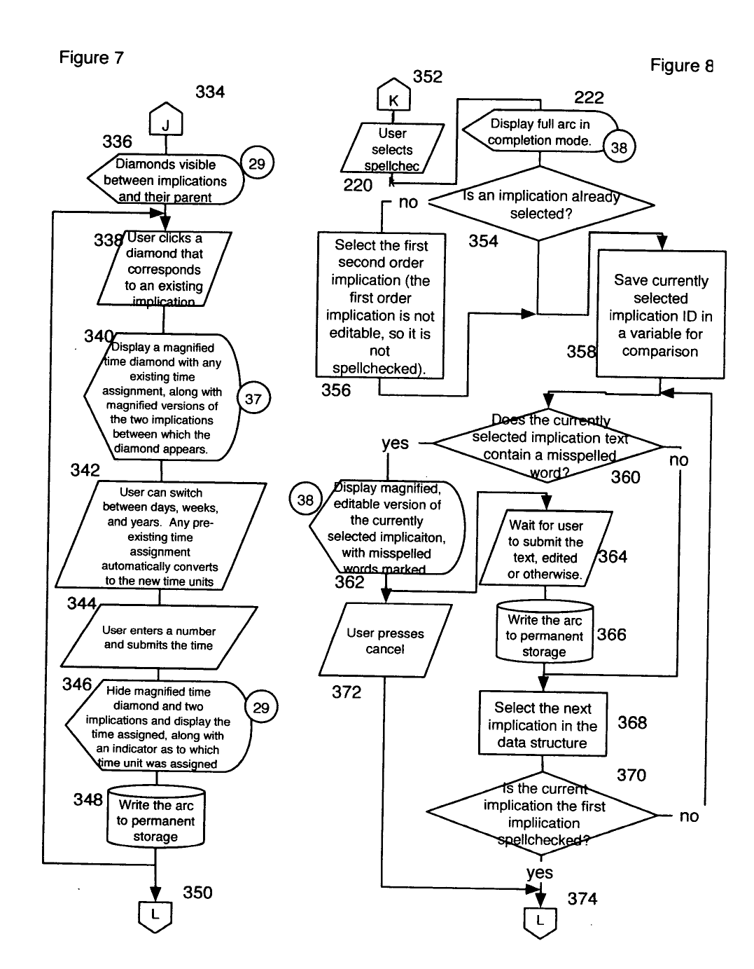

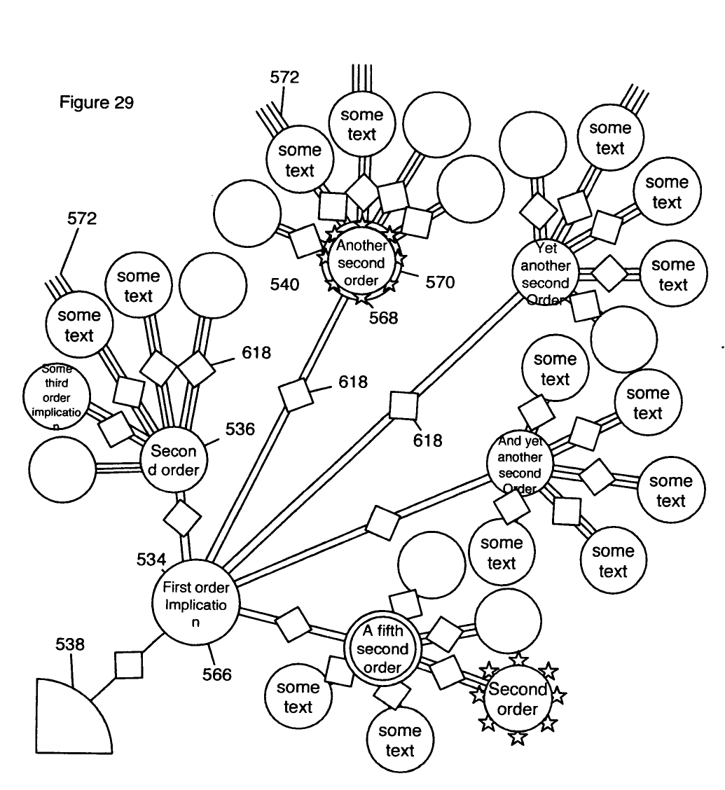

The user may select timing from an assigned point of view, parallelogram 214. The full arc is displayed in timing mode, oval-arrow 216, as shown in FIG. 29. This option may not be made available if timing has not been assigned. The user is then directed, pentagon 218, to the method step concerning timing, pentagon 334 of FIG. 7.

The user may select spell check, parallelogram 220. The full arc is displayed in completion mode and spell check is started, oval-arrow 222 as shown in FIG. 21. The user is then directed, pentagon 224, to the steps concerning spell checking as set forth at pentagon 352 of FIG. 8.

The user may select to return a completed arc, parallelogram 226. A process step, rectangle 228, of logging in to the data server over a secure channel with locally stored login information. The arc data is encrypted and returned to the server. This may be an asynchronous process. The user is then directed, pentagon 230, to the method steps following from pentagon 101 of FIG. 1.

Alternatively, the user may select quit or exit, parallelogram 232. The program then terminates, oval 234.

Note, at various points in the display if any implication has more than a predetermined number of implications, perhaps five, a “next page” button 592 will be presented for any additional implications and if any implication has a multiple of the predetermined number, perhaps five, a “new page” button 592 will be displayed for allowing additional implications to be placed on a new page.

Editing Nodes

The user may reach the editing nodes function through pentagon 236. Thereafter, the user may click a second or third order node 536, 540, parallelogram 240. Completing third order nodes 540 is precluded if there are not at least one positive and one negative second order node 536 as previously described, diamond 200 of FIG. 3. A decision is made as to whether the selected node corresponds to an implication that has already been generated, diamond 242. If no, the user is directed, pentagon 244, to pentagon 264 of FIG. 5.

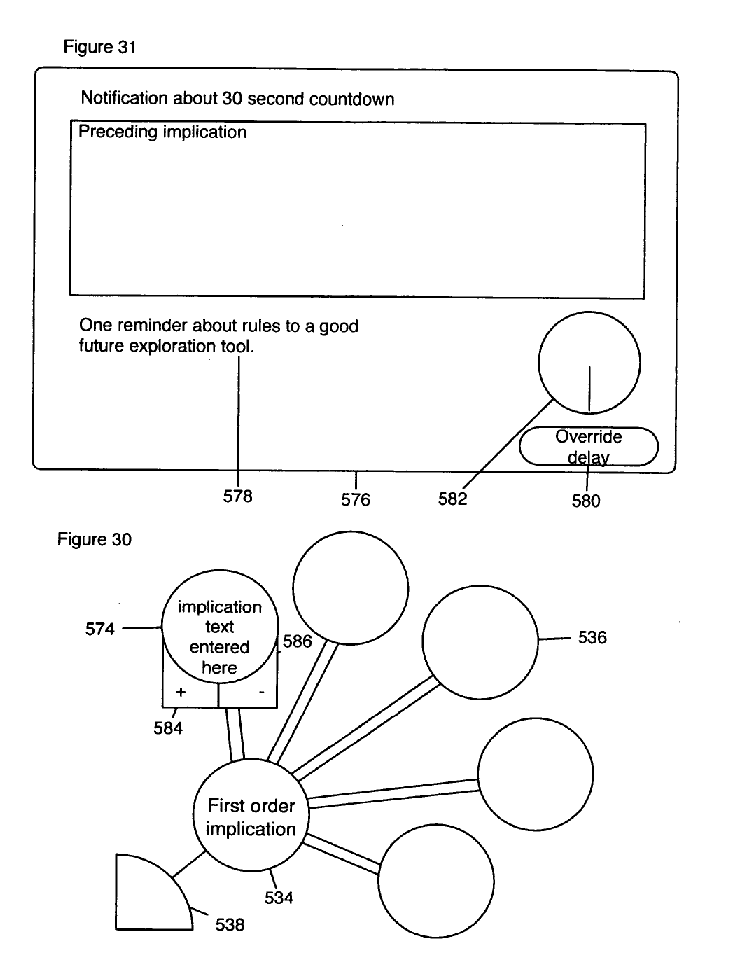

If the selected node corresponds to a previously generated implication, the text entry display 574 is presented over the selected node containing the implication text, oval-arrow 248, as shown in FIG. 30. The user may edit the text and submit the changes, perhaps with the << enter>> key, <<tab>> key or clicking on the screen in a location unrelated to the node, rectangle 250. Positive and negative scoring may be changed on the implication, preferably by changing the plus or minus indicator near the beginning of the text display.

A decision is made, diamond 252, as to whether there are four or more sibling nodes, e.g. children of the current parent node. If no, the method is directed to the step described in regard to the step set forth in rectangle 254, which will be described in a moment. If yes, a decision is made as to whether there is at least one positive child of the current parent node, diamond 256. If no, the user is reminded to include at least one positive implication, parallelogram 258, and directed to the step indicated in rectangle 254. If there is at least one positive child of the current parent node, a decision is made as to whether there is at least one negative child implication of the current parent implication, diamond 260. If no, the user is reminded to include at least one negative implication, parallelogram 262, and is directed to the step described in regard to rectangle 254. If there are four or more children nodes of the current parent node and at least one is positive and one is negative, the user moves directly to the process step set forth in rectangle 254.

At rectangle 254, the text of the selected implication is changed in the data structure representing the arc. The arc is written to permanent storage, cylinder 261. The user has the option of repeating the afore described steps in editing another implication or returning to pentagon 180 of the completion interface described with reference to FIG. 3, pentagon 263.

Currently Unidentified Implications

This process has been found to inspire users to be aggressive on sharing implications and less aggressive on forethought. Accordingly, the process may include a step to relax the user and allow them time to think. After reaching pentagon 244 of FIG. 4, the user is directed to pentagon 264 of FIG. 5. There a decision is made as to whether the user has had the thirty second timer displayed, diamond 266. A pause window 576, perhaps thirty-seconds in duration may be presented together with a display of rule reminders 578, which can vary as to which rules are presented, and the text of the parent implication of the selected node, oval-arrow 268. This pause may include a delay override button 580 and visible countdown indicator 582, preferably analog clock style, oval-arrow 268.

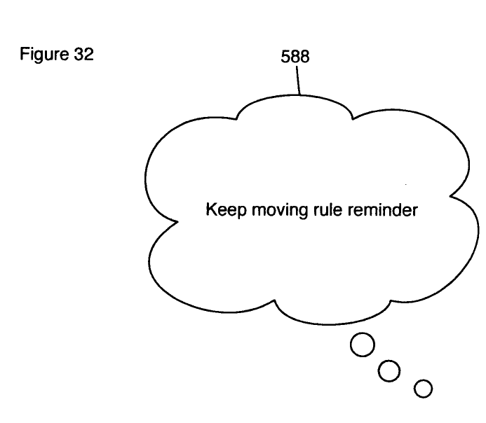

Once the pause is initiated, previously or currently, the text entry display 574 may be presented over the selected node with positive and negative selection buttons 584, 586, oval-arrow 270, as shown in FIG. 30. A progress reminder may be used to keep progress moving, essentially another clock that determines whether the user taken more than a predetermined amount of time between entry of data. A decision is made as to whether the progress reminder delay passed, diamond 272. If the delay passed, the user is reminded, perhaps with window 588, that the progress should continue, oval-arrow 274 as shown in FIG. 32. Once reminded or if the delay did not pass, the user may enter an implication and designating the implication as positive or negative with buttons 584 and 586, parallelogram 276. Positive or negative may be selected using the tab key to highlight the correct button followed by the <<enter>> key or via clicking with a mouse. A decision is made as to whether there are four or more children of the current parent node, diamond 278. If not, the method is directed to the step identified in rectangle 288, which will be discussed in a moment.

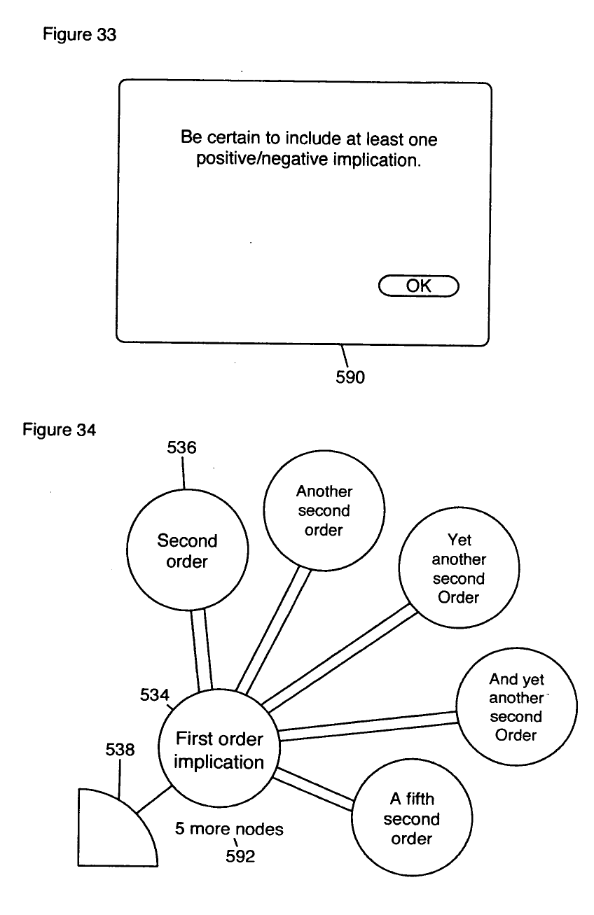

When four or more children of the selected parent node are present, a test is initiated to determine that both positive and negative implications are present. At diamond 280, a decision is reached as to whether there is at least one positive child of the select parent node. If no, the user is reminded, perhaps with window 590 of FIG. 33, to include at least one positive implication, oval-arrow 282 and is directed to rectangle 288. If there is a positive implication, a decision is made as to whether there is at least one negative implication, diamond 284. If no, the user is reminded to include at least one negative implication, perhaps in window 590 of FIG. 33, oval-arrow 286 and is directed to rectangle 288. The method proceeds to rectangle 288 if there is both a positive and a negative implication.

At rectangle 288, an implication is created in the arc data structure as a child of the selected parent implication with a positive or a negative value corresponding to the selected button and text corresponding to the user entered text. The arc is then written to permanent storage, cylinder 290.

A decision is then made as to whether there is a multiple of a predetermined number of children, perhaps five, of the selected parent implication, diamond 292. If so, an option 592 is displayed for another page of the predetermined number of children as shown in FIGS. 21 and 34, oval-arrow 294. Either after such display or if there is not a multiple of the predetermined number, the user is presented with two options. The user may exit this portion of the methodology through pentagon 298, bringing the user back to the completion interface, pentagon 180 of FIG. 3. Alternatively, the user may have the method automatically select the next empty node, i.e. a node without a corresponding implication, rectangle 296. After such selection, the method resumes the course previously described starting with oval-arrow 270.

Scoring in Completion Mode Upon entering, pentagon 330 of FIG. 6, the function for scoring in completion mode, un-scored existing implications are displayed in the scoring mode with an un-scored visual indicator, such as blurriness or jagged edges 564 defining the node together with the other previously described scoring indicators 566, 568 and 570 as shown in FIGS. 23 and 24, oval-arrow 302. The user may select a node that corresponds to an existing implication, parallelogram 304. Next, diamond 306, a decision is made by the method as to whether the scoring is “fast” mode or “detailed” mode. The fast mode gathers less precise information then the detailed mode. An appropriate scoring interface is displayed for the particular scoring mode as described below.

The “detailed” scoring interface, such as that shown in FIG. 23 and indicated in oval-arrow 308, shows the buttons 594 for indicating desirability, buttons 596 for indicating likelihood, and a minority report interface button 598. Preferably, the buttons 594 for desirability include a wide range of numerical indicators such as +50, +5, +4, +3, +2, +1, 0, −1, −2, −3, −4, −5, and −50. The desirability buttons 594 are used to indicate the preference of the occurrence of the implication. Such desirability buttons 594 may be color coded, perhaps in a gradient manner, perhaps with blue positive numbers with white or pale tones representing more neutral numbers and red representing the negative numbers. Preferably, the likelihood buttons 596 include a wide range of numerical indicators such as 90%, 80%, 70%, 60%, 50%, 40%, 30%, 20%, and 10% or 9, 8, 7, 6, 5, 4, 3, 2, and 1. For instance somebody may identify world peace as an implication of a summit meeting. Desirability may be marked as +50 according to a scoring method, but likelihood may be scored as 10% or 1. The node may be displayed, perhaps as a magnified node, together with any indicators showing its existing score.

The “fast” scoring interface, such as that shown in FIG. 24 is displayed, oval-arrow 310, showing the buttons 600 for indicating desirability, buttons 602 for indicating likelihood, and a minority report interface 604. Preferably, the buttons 600 for desirability include a smaller number of options of numerical indicators such as +50, +5 or +4, +3 to −3, −4 or −5, and −50. The desirability buttons are used to indicate the preference of occurrence of the implication. Such desirability buttons 600 may be color coded, perhaps in a gradient manner, perhaps with blue positive numbers with white or pale tones representing more neutral numbers and red representing the negative numbers. Preferably, the likelihood buttons 602 include a smaller number of options of numerical indicators perhaps being “greater than 70%” and “less than or equal to 70%”. The node may be displayed, perhaps as a magnified node, together with any indicators showing its existing score.

From the steps described in regard to oval-arrows 308 and 310, the method seeks input from the user, parallelogram 312. The user assigns desirability and likelihood to the implications by clicking on the scoring buttons 595 and 596 or 600 and 602. A response including both desirability and likelihood is required before the process can continue, except perhaps in fast scoring mode where a desirability of +3 to −3, e.g. neutral, does not require a likelihood scoring.

Next, rectangle 314, the scored nodes are colored and shaped to visually indicate the desirability and likelihood combinations. Any prior scoring or non-scored, e.g. un-scored, indicators are removed in this process. FIGS. 23 and 24 are examples of different visual indicators that may be used to depart information about scored and un-scored nodes. For example, nodes that have not been scored remain blurry or with jagged edges 564. Nodes that are not a child of the selected node may be presented in a small or abbreviated manner. Scored nodes may be shown with a smooth non-jagged outer perimeter such as nodes 566. Significant nodes may be identified with stars such as nodes 568. Nodes with a high likelihood, e.g. greater than 70% may be visually identified with a second ring 570 about the node. That is, those with a significant desirability score and significant likelihood may be made more prominent so as to draw the viewer's attention to those nodes of the greatest impact and those of less impacting and less likely implications are displayed less prominently. Any scored node that was previously visually marked as un-scored loses its visual “un-scored” indicator when it is scored.

The arc data is written to permanent storage, cylinder 316. The method waits for either of three inputs, the user may submit a minority report, parallelogram 318, the user may score another node, as was described starting at parallelogram 304, or the user may go to the completion interface, pentagon 320 of FIG. 6 and pentagon 180 of FIG. 3.

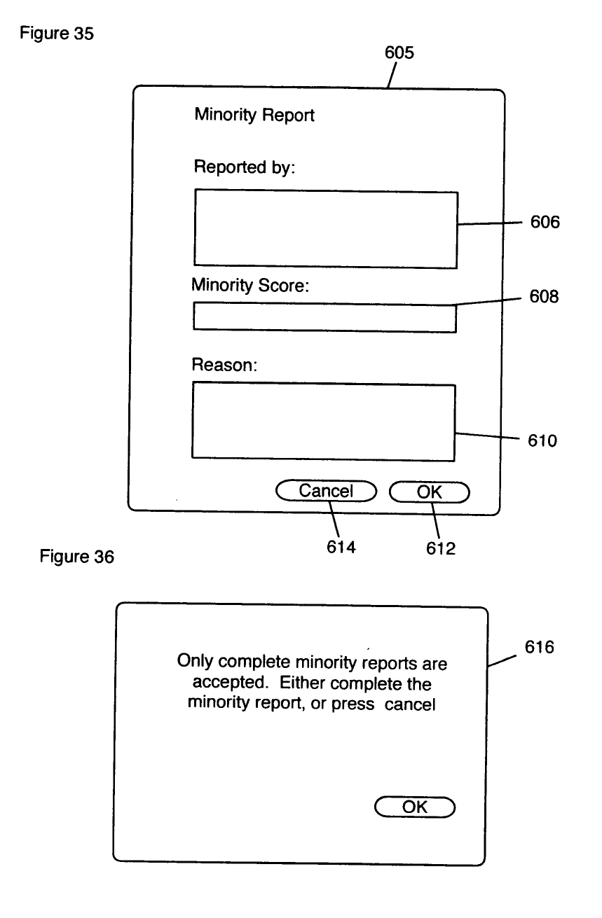

When the user clicks the minority report button 598 or 604, parallelogram 318, the minority report interface 605 is displayed, oval arrow 320. The minority report interface 605, shown in FIG. 35 preferably has fields for identification of the reporter(s) 606, minority score 608 and reason for minority report 610. The user may click “o.k.” on button 612 or “cancel” on button 614 (or similar indicators of action), parallelogram 322. If “cancel” is selected, button 614, the minority report interface 605 is hidden, oval-arrow 324, and the method waits for user selection of one of the three choices identified with regard to cylinder 316. If “O.k” button 612 was selected, a decision is made as to whether all required fields, perhaps 606, 608, and 610 of the minority report interface 605 are completely filled. Preferably all fields are required, diamond 326. If not, the user is notified, perhaps with window 616 of FIG. 36 that only complete minority reports will be submitted, oval-arrow 328, and the method is redirected to the point previously described with reference to parallelogram 322. If complete, the minority report is recorded in the current implication and a visual indicator for a minority report, such as a subscript or superscript “M”, may be displayed next to the node that has a minority report, rectangle 330. Completion of the process step in rectangle 330, is followed with hiding of the minority report entry interface, oval-arrow 332. The arc data is written to permanent storage as previously described in regard to cylinder 316 and resumes the method as previously described with regard to cylinder 316.

Timing

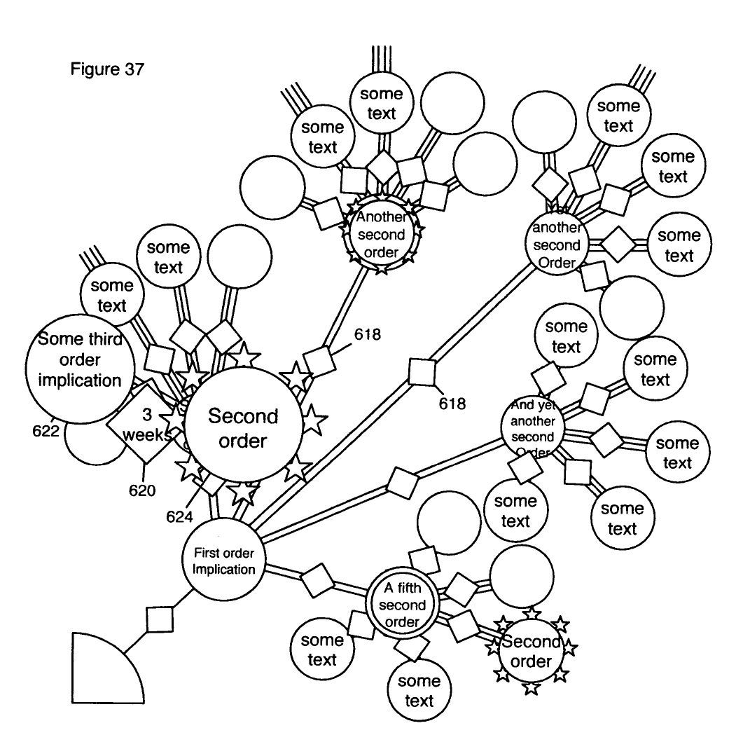

Timing allows for users to estimate the amount of time that it may take to pass from the occurrence of one implication on through to a higher order implication directly resulting therefrom. The timing function, entered through pentagon 334 of FIG. 7, accessible from pentagon 218 of FIG. 3, first displays diamonds 618 between ancestral implications, oval-arrow 336, as shown in FIGS. 29 and 37. The user may select a diamond that corresponds to an existing implication, parallelogram 338. A magnified time diamond 620 may be displayed with any existing time assignment along with magnified nodes 622, 624 between which the time diamond is preferably positioned in the wheel, oval-arrow 340, as shown in FIG. 37.

The user may switch between days, weeks and years and any pre-existing time units automatically convert to the newly selected units of time measure, parallelogram 342. The user may enter a number and submit the information, perhaps through clicking, using the <<enter>> key or <<tab>> key or other method, parallelogram 344. The magnified time diamond 620, two magnified nodes 622, 624, assigned time and any indicator as to time units are hidden, oval-arrow 346, as shown in FIG. 29. The data is written to permanent storage for later retrieval and use, cylinder 348. The user may repeat the process, starting at parallelogram 338 or return to the completion interface, pentagon 350 of FIG. 7 and pentagon 180 of FIG. 3.

Spell Check

FIG. 8 discloses the process whereby a user may spell check the text within the nodes, entered from pentagon 352. A decision is made as to whether an implication has already been selected, diamond 354. If not, then the method selects the first second order implications, rectangle 356. Since the first order implication is not editable, it cannot be spell checked. Once an implication has been selected, either via the user or the method, the currently selected implication identification is saved in a variable for comparison, rectangle 358. The implication is then evaluated to determine if it has a misspelled word, diamond 360.

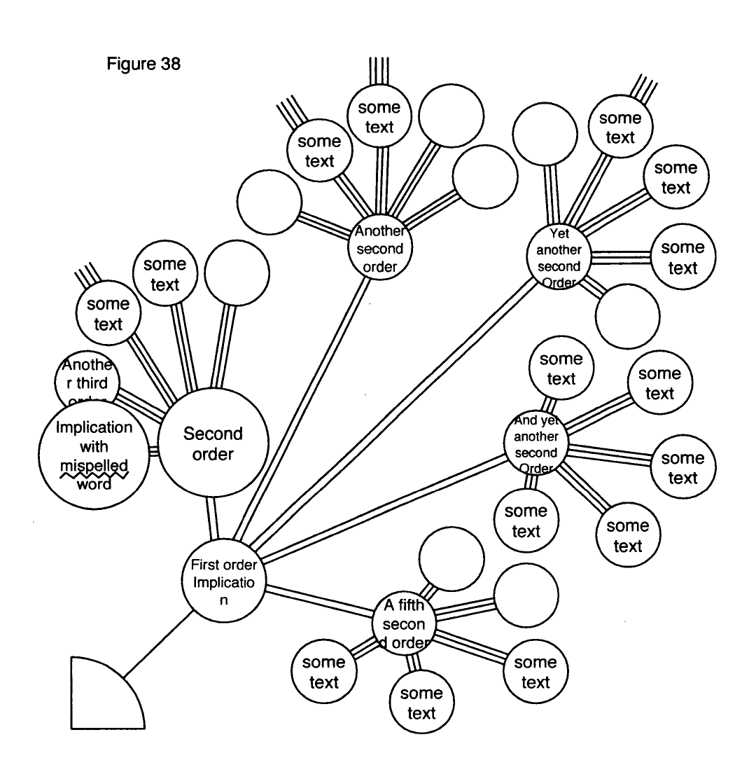

Implications that have a misspelled word are displayed in a magnified node 626 in an editable mode with the misspelled words marked with indicia 628, oval-arrow 362 as shown in FIG. 38. The user may submit the text, edited or otherwise, perhaps by pressing <<enter>>, <<tab>> or clicking, parallelogram 364. The arc is written to permanent storage, cylinder 366. The next implication in the data structure is selected, rectangle 368. The step at rectangle 368 is also directly reachable from diamond 360 if the implication has not misspelled words. The process repeats the steps between diamond 360 and rectangle 368 until all implications have been spell checked, diamond 370, or until the user selects cancel, parallelogram 372. Upon completion or termination, the user is directed to the completion interface through pentagon 374 of FIG. 8 and pentagon 180 of FIG. 3.

Scoring Interface

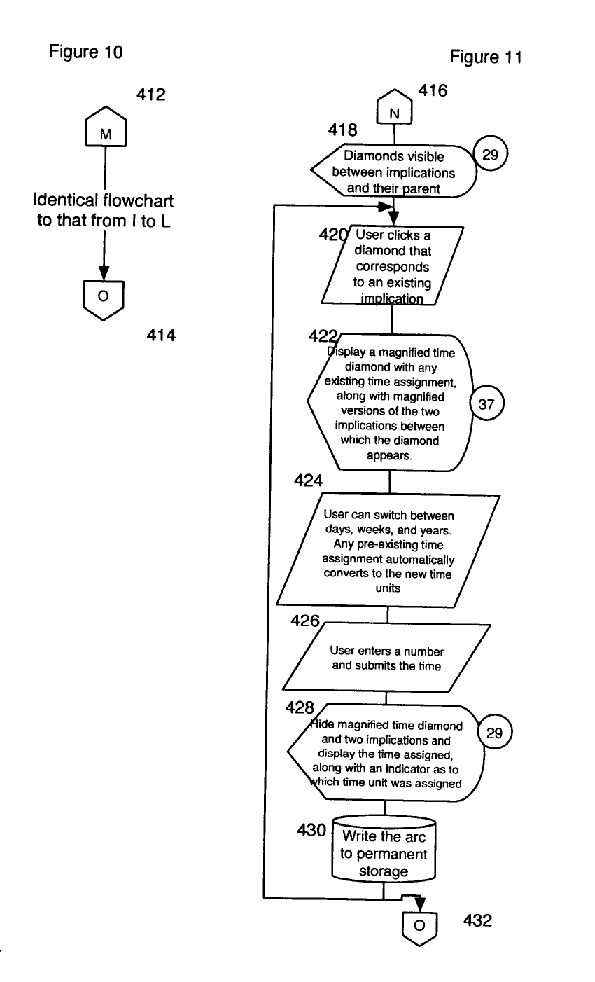

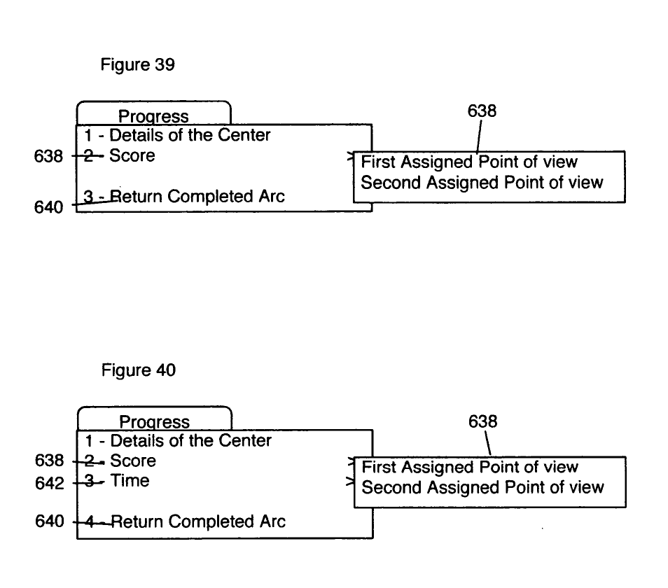

The scoring interface, entered through pentagon 376, accessible through pentagon 176 of FIG. 2, i.e. only if scoring was assigned, first determines whether time was assigned, diamond 378. Note, that the flow chart diamonds and time diamonds are different in nature with flow chart diamonds indicating a decision making point and time diamonds recording an estimated time that would elapse between two implications if such implications do occur. If time was not assigned, the interface is displayed with options to open another arc 546 (FIG. 25), quit/exit 548 (FIG. 25), score from all assigned points of view 638 (FIG. 39), and return the completed arc 640 (FIG. 39), oval-arrow 380. If time was assigned, the user has the options of open another arc 546 (FIG. 25), quit/exit 548 (FIG. 25), score from all assigned points of view 638 (FIG. 39), time from all assigned points of view 642 (FIG. 39) and return the completed arc 640 (FIG. 39), oval-arrow 382. Presentation of these options may also occur through pentagon 384. (See pentagon 414 of FIG. 10).

The user has the option to open another arc, parallelogram 386, which if selected directs the user back to diamond 102 of FIG. 1 via pentagons 388 and 101.

The user has the option to score from all assigned points of view, parallelogram 390. If selected, the full arc is displayed in scoring mode as shown in FIGS. 23 and 24. Un-scored implications are marked with indicia 564, such as blurry lines or jagged edges, to designate the nodes as un-scored, oval-arrow 392. The user is directed to FIG. 10 via pentagon 394 (FIG. 9) and pentagon 412 (FIG. 10). Between the pentagons 412 and 414 on FIG. 10, the flowchart is preferably identical to that in FIG. 6 with the difference being the entrance and exit points.

The user may select timing from one assigned point of view, parallelogram 396. The full arc is displayed in timing mode as shown in FIG. 29, oval-arrow 398, and the user is directed to the steps identified on the flowchart in FIG. 11, see pentagons 400 (FIG. 9) and 416 (FIG. 11).

The user may select to return the completed arc, parallelogram 402. A process, rectangle 404, occurs such as logging in to the data server over secure channels with locally stored login information. The content data is encrypted and the arc is returned to the server. This may be an asynchronous process. The user is directed to the step previously described in regard to diamond 102 of FIG. 1 via pentagons 406 (FIG. 9) and 101 (FIG. 1).

The user may select to quit/exit the process, parallelogram 408, which terminates the methodology, oval 410.

Scoring in Scoring Mode

The flowchart in FIG. 10 denotes that the process is preferably substantially the same as that shown in FIG. 6. FIG. 6 is the scoring process that occurs when the user accesses scoring from the completion interface of FIG. 3 and FIG. 10 is the scoring process that occurs when the user accesses scoring from the scoring interface of FIG. 9. While the scoring process remains substantially unchanged, the interface where the user starts is the interface to where the user should be returned upon completion of scoring. The user is returned to the interface from where they initiated the scoring process as indicated by the pentagons 180, 212 of FIGS. 3 corresponding with pentagons 300 and 320 of FIG. 6 as compared with pentagons 384 and 394 of FIG. 9 corresponding with pentagons 412 and 414 of FIG. 10.

Timing

A user may select to enter time from the scoring interface, FIG. 9, wherein the user was directed from pentagon 400 of FIG. 9 to pentagon 416 of FIG. 11. Time diamonds are made visible between implications and their parent, oval-arrow 418 as shown in FIG. 29. The user may click a diamond that corresponds to an existing implication, parallelogram 420. The time diamond 618 may be displayed as a magnified diamond 620 together with and existing time assignment, along with magnified versions of the two implications 622, 624 between which the time diamond 620 appears, oval-arrow 422, as shown in FIG. 37.

The user may select the units of time measure, e.g. days, weeks, and years, parallelogram 424, and any pre-existing time assignment is converted to the newly selected units of time measure. The user may enter a number of units, e.g. three days or four weeks, etc., and submit the information preferably via pressing the <<enter>> key, <<tab>> key or clicking, parallelogram 426. Upon submission, the magnified time diamond 620, the two implications 622, 624 and the indicator as to units of measure are removed from display as shown in FIG. 29, oval-arrow 428. The arc is then written to permanent storage, cylinder 430. The user may select another time diamond, parallelogram 420, or return to the scoring interface, pentagon 432 (FIG. 11) and pentagon 384 (FIG. 9).

The appended computer program coding is offered as a further description to those skilled in the art of computer programming to more fully understand the present invention and further explain the subject matter described herein.

Although the present invention has been described with reference to preferred embodiments, workers skilled in the art will recognize changes may be made in form and detail without departing from the spirit and scope of the invention. For instance, different indica and shapes may be used to impart information concerning the nodes and scoring thereof.

1) A method of investigating, comprising the steps of:
selecting an option of complete third order nodes;
determining whether there is at least one positive and at least one negative second order implications; and
precluding presentation of third order nodes until at least one positive and at least one negative second order implications are present.

2) The method of claim 1 further comprising the steps of:
determining if the arc was assigned for completion;
determining whether second order implication stage is complete if the arc was assigned for completion; and
displaying the entire arc only when the second order implication stage is complete.

3) The method of claim 1 further comprising the steps of:
selecting an option of complete third order nodes;
determining whether there is at least one positive and at least one negative second order implications; and
presenting third order nodes only when there is at least one positive and at least one negative second order implication.

4) The method of claim 1 further comprising the steps of:
determining if the arc was assigned for completion; and
directing the user to a completion interface when the arc was assigned for completion.

5) The method of claim 4, further comprising the step of:
determining whether time was assigned: and
if time was assigned presenting options at the completion interface of open another arc, complete second order nodes, complete third order nodes, scoring from any assigned point of view, timing from one assigned point of view, return completed arc, and quit.

6) The method of claim 4, further comprising the step of:
determining whether time was assigned: and
if time was not assigned presenting options of open another arc, complete second order nodes, complete third order nodes, scoring from any assigned point of view, return completed arc, and quit and precluding an option of timing from all assigned points of view.

7) The method of claim 1, further comprising the steps of:
determining the status of the subscription;
if the subscription is valid presenting options of downloading assigned arcs, selecting to update the subscription to the status stored on the server side, and selecting a center;
if the subscription is expired presenting options of selecting to update the subscription to the status stored on the server side, and selecting a center and precluding downloading of assigned arcs; and
if the subscription is not registered, presenting the option of selecting to update the subscription to the status stored on the server side until receipt of a communication of a valid subscription from the server side and precluding downloading of assigned arcs and selection of a center.

8) The method of claim 1 further comprising the steps of:
selecting a center; and
displaying arcs assigned from a selected center after selection of the center.

9) A method of investigating, comprising the steps of:
selecting one of complete second order nodes and complete third order nodes;
delaying for a period of time to allow a user to think about implications;
maintaining a clock for a period of time measuring delay between user input; and
displaying a reminder to the user to provide input if a predetermined amount of time has passed from the last receipt of input.

10) A method of investigating, comprising the steps of:
determining if scoring was assigned; and
disabling editability of implication text if only scoring was assigned.

11) The method of claim 10 further comprising the steps of:
permitting scoring of an arc only when scoring is assigned.

12) The method of claim 10 further comprising the steps of:
directing a user to a scoring interface if scoring was assigned.

13) The method of claim 10 further comprising the step of:
displaying desirability buttons and likelihood buttons when scoring.

14) The method of claim 10 further comprising the step of displaying a minority report button.

15) The method of claim 14 further comprising the step of:
displaying a minority report interface when the minority report button is clicked.

16) The method of claim 15 further comprising the step of:
verifying that the minority report interface is fully prepared prior to accepting any data contained in the report; and
precluding acceptance of an incomplete minority report.

17) The method of claim 10 further comprising the steps of:
determining whether time was assigned at a scoring interface;
displaying options of open another arc, quit, score from all assigned points of view and return completed arc; and
precluding an option of time from assigned all point of view if time was not assigned.

18) The method of claim 10 further comprising the steps of:
determining whether time was assigned at a scoring interface;
displaying options of open another arc, quit, score from all assigned points of view, time from all assigned points of view, and return completed.
